(19) United States
(12) Patent Application Publication
(10) Pub. No.: US 2026/0210807 A1
(43) Pub. Date: Jul. 23, 2026

(54) Wheel Load Determining Apparatus and Method

(71) Applicant: Moveero Limited, Telford (GB)

(72) Inventors: Gianpietro Bramè, Brescia (IT); Vincenzo Zuccarotto, Brescia (IT)

(21) Appl. No.: 19/137,117

(22) PCT Filed: Dec. 12, 2023
(86) PCT No.: PCT/GB2023/053203

§ 371 Date: Jun. 9, 2025

(30) Foreign Application Priority Data
Dec. 12, 2022 (GB) 2218680.3

(51) Int. Cl. G01M 17/013; B60C 23/00; B60C 23/06; G01L 1/22; G01L 17/00

(52) U.S. Cl. CPC G01M 17/013; B60C 23/001; B60C 23/064; G01L 1/22; G01L 17/00

(57) ABSTRACT

A wheel load determining apparatus (10, 100) for determining a wheel load acting on a vehicle wheel (34, 134) including: a beam (12, 112) configured to transfer a load component between a first assembly part (33a, 133a) and a second assembly part (33b, 133b) of a wheel assembly (33, 133), at least one strain gauge (14) positioned on a surface of the beam (12, 112) and configured to measure a deformation of the beam due to the wheel load component and to provide a signal indicative of the deformation of the beam to a controller (32) configured to receive a signal indicative of deformation of the beam, and to determine a value indicative of a bending moment acting on the beam (12, 112), as a result of the load component, wherein the controller (32) determines the wheel load acting on the vehicle wheel (34, 134) based on the determined value indicative of bending moment and a load function M(L) which represents a relationship between the value indicative of bending moment and the wheel load.

### FIELD

This invention relates to a method and apparatus for determining a load acting on a vehicle wheel. More specifically, but not exclusively, the invention relates to the determination of a load acting on the wheel of an agricultural vehicle.

### BACKGROUND

Agricultural vehicles need to travel over a range of different types of terrain. When working off highway, the vehicles must be able to maintain traction without unduly compressing the soil under a vehicle tyre. When travelling on the highway the vehicles must be able to travel efficiently at speeds that are appropriate to the road conditions, without causing undue tyre wear.

Tyre pressure is an important factor when considering the traction requirements when on or off highway. When working in the field, a lower tyre pressure is advantageous. A low tyre pressure will allow the vehicle tyre to deflect under the weight of the vehicle. This provides the vehicle with a greater contact area with the ground. This reduces the compaction of soil under the tyre. The greater contact area also increases the grip available to the vehicle, which makes the vehicle easier to drive and leads to a reduction in the amount of wheel slip that occurs in comparison to a vehicle that has a higher tyre pressure, and therefore a lower contact area. Reducing wheel slip ensures that a greater proportion of tractive force provided by the engine to the wheels is used to move the vehicle. This may result in a higher overall fuel efficiency.

When driving on the highway, higher tyre pressures are advantageous. Higher pressures allow the vehicle to travel safely at higher speeds and can lead to reduced tyre wear.

Centralised tyre pressure control systems are increasingly common on agricultural vehicles. Such systems allow a user to increase or decrease the pressure of the tyre depending on the type of terrain that the vehicle is likely to encounter. The pressure control system is typically activated to adjust tyre pressure when changing between terrains and may be operable to determine an optimised tyre pressure dependent on the wheel load and type of terrain.

To optimise the tyre pressure for a given surface, the load on the wheel may be estimated. There are several known methods of estimating the load on a wheel. The simplest method of estimation of the wheel load may be made based on the type of vehicle. This data may be correlated with the unladen vehicle weight provided by the manufacturer. However, any loads in excess of the unladen vehicle weight are difficult to estimate. This method lacks the accuracy required to optimise the required tyre pressures.

A second method of estimating wheel load is based on the deformation of a tyre. Such a method considers the change in tyre radius or tyre footprint for a given tyre pressure. Estimating the load on the wheel in this way is highly dependent on the tyre construction and such a system requires extensive data from tyre manufacturers.

A further method of measuring mechanical loads is known from US2015/0053487 A1. The document describes determining the mechanical loads on a vehicle wheel based on measurements of strain in the wheel rim. It has been found that the strain gauge signal amplitude at this location is influenced not only by the applied load, but by the tyre pressure and tyre construction. The same load at different tyre pressures will give different strain gauge signal values and is therefore unsuitable for a method of measuring load that is to be used over a range of tyre pressures. Furthermore, at constant pressure, the relationship between the rim deformation and the applied load is not linear, adding complexity to the method of estimating the load.

The present invention seeks to reduce or overcome one or more of the deficiencies associated with the prior art.

### BRIEF DESCRIPTION OF THE INVENTION

The present invention seeks to address the issues outlined above by providing an apparatus and a method for determining a load on a vehicle wheel. The described apparatus and/or method may be suitable for use while the vehicle is in operation, for instance while the vehicle is moving or otherwise working. The load that is determined by such an apparatus and/or method may be used to set a target tyre pressure dependent on a wheel load and type of terrain that the vehicle is, or will be, working in.

There is provided a wheel load determining apparatus for determining a wheel load acting on a vehicle wheel, wherein the wheel is part of a wheel assembly, the wheel assembly including a first assembly part and a second assembly part, wherein a component of the wheel load is transferred between the first assembly part and the second assembly part, the wheel load determining apparatus including at least one strain gauge positioned and configured to measure deformation between the first assembly part and the second assembly part, and to provide a signal indicative of measured deformation to a controller configured to receive a signal indicative of deformation and to determine a value indicative of a bending moment resulting from the component of the wheel load, wherein the controller determines the wheel load acting on the vehicle wheel based on the determined value indicative of the bending moment acting on the beam and a load function which represents a relationship between the value indicative of bending moment and the wheel load.

The wheel load determining apparatus may include:
a beam configured to transfer a load component between a first assembly part and a second assembly part of a wheel assembly
at least one strain gauge positioned on a surface of the beam and configured to measure a deformation of the beam due to the wheel load component and to provide a signal indicative of the deformation of the beam, to
a controller configured to receive a signal indicative of deformation of the beam, and to determine a value indicative of a bending moment acting on the beam, as a result of the load component,
wherein the controller determines the wheel load acting on the vehicle wheel based on the determined value indicative of bending moment and a load function which represents a relationship between the value indicative of bending moment and the wheel load.

The first assembly part of the wheel assembly may be one of a part of a rim of the vehicle wheel and a part of a disc of the vehicle wheel and the second assembly part may be one of a part of the disc and a hub.

The first assembly part may be a part of the vehicle wheel.

The first assembly part may be a part of a disc of the vehicle wheel, for example a first part of the disc.

The first assembly part may be a part of a rim of the vehicle wheel.

The second assembly part may be a part of the disc of the vehicle wheel, for example a second part of the disc.

The second assembly part may be a part of a hub of the wheel assembly.

The beam may provide a connection between the first assembly part and the second assembly part.

The beam may comprise a threaded portion.

The beam may form part of a bolted joint between the first assembly part and the second assembly part.

A conical or spherical nut may be used to fasten the beam in the bolted joint.

The strain gauges may each be positioned on a surface of the beam, and each may be operable to measure a component of the deformation of the beam.

There is provided a tyre pressure control system configured to monitor the pressure of a vehicle tyre, wherein the tyre pressure control system is configured to receive data indicative of a wheel load from a wheel load determining apparatus as described herein.

The tyre pressure control system may be configured to use the data indicative of a wheel load received from the wheel load determining apparatus to determine and/or monitor pressure of the vehicle tyre, and the tyre pressure control system may be operable to determine whether the tyre pressure is within a predetermined range.

The tyre pressure control system may be operable to provide an indication to a user that the tyre pressure is and/or is not within the predetermined range.

The tyre pressure control system may be operable to provide a signal that enables automatic adjustment of the tyre pressure.

There is also provided a vehicle wheel including a wheel load determining apparatus as described herein.

There is also provided a vehicle including a vehicle wheel, the vehicle wheel including a wheel load determining apparatus as described herein.

The vehicle may include a tyre pressure control system. The vehicle may be a centralised tyre pressure control system.

There is provided a method of determining a wheel load acting on a vehicle wheel, the wheel being part of a wheel assembly including a first assembly part and a second assembly part, a component of the wheel load being transferred between the first assembly part and the second assembly part, the method including the steps of:
providing a wheel load determining apparatus, including:
   at least one strain gauge configured to measure deformation of the beam due to the wheel load component and to provide a signal indicative of the deformation, and
   a controller configured to receive signals indicative of deformation and to determine a value indicative of a bending moment acting on the beam;
measuring deformation between the first assembly part and the second assembly part due to a wheel load using the at least one strain gauge,
receiving a signal indicative of deformation at the controller,
determining a value indicative of a bending moment due to the component of the wheel load, using the signal indicative of deformation, and
determining the wheel load acting on the vehicle wheel,
wherein the determination of the wheel load acting on the vehicle wheel is based on the value indicative of bending moment and a load function which represents a relationship between the value indicative of bending moment and the wheel load.

The method may include the steps of:
providing a wheel load determining apparatus, that includes:
   a beam operable to transfer a component of the load between the first assembly part and the second assembly part,
   providing at least one strain gauge configured to measure deformation of the beam due to the component of the wheel load and to provide a signal indicative of the deformation of the beam, and
   providing a controller operable to receive signals indicative of the deformation of the beam and to determine a value indicative of a bending moment acting on the beam,
measuring the deformation of the beam due to a wheel load using the at least one strain gauge operable to measure strain in the beam,
receiving a signal indicative of deformation of the beam at the controller,
determining a value indicative of bending moment acting on the beam due to the wheel load using the signal indicative of deformation of the beam, and
determining the wheel load acting on the vehicle wheel,
wherein the determination of the wheel load acting on the vehicle wheel is based on the value indicative of bending moment acting on the beam and a load function which represents a relationship between the value indicative of bending moment and the wheel load.

The first assembly part of the wheel assembly may be one of a part of a rim of the vehicle wheel and a part of a disc of the vehicle wheel and the second assembly part may be one of a part of the disc of the vehicle wheel and a hub.

The first assembly part may be a part of the vehicle wheel.

The first assembly part may be a part of a disc of the vehicle wheel, for example a first part of the disc.

The first assembly part may be a part of a rim of the vehicle wheel.

The second assembly part may be a part of the disc of the vehicle wheel, for example a second part of the disc.

The second assembly part may be a part of a hub of the wheel assembly.

Determination of the operating wheel load may include a calibration phase, the calibration phase including:
measuring a first deformation of the beam at a first known wheel load, using at least one strain gauge,
measuring a second deformation of the beam at a second known wheel load, using at least one strain gauge,
calculating a first value indicative of bending moment acting on the beam at the first known wheel load,
calculating a second value indicative of bending moment acting on the beam at the second known wheel load,
determining the load function of value indicative of bending moment acting on the beam with respect to wheel load using the first known wheel load, the first value indicative of bending moment, the second known wheel load and the second value indicative of bending moment.

The value indicative of the bending moment acting on the beam may be calculated using one of:

$$M = \frac{IE}{\sqrt{3} r cos γ} ( {∈}_{3} - {∈}_{2} )$$

$$where$$

$$γ = {tan}^{- 1} \{ \frac{1}{\sqrt{3}} \vert 1 - \frac{2 ( {∈}_{1} - {∈}_{3} )}{( {∈}_{2} - {∈}_{3} )} ] \}$$

and:
M=the bending moment acting on the beam
E=Modulus of elasticity of the beam
I=Moment of inertia of the beam
r=radius of cross section of the beam
∈₁=strain at a first strain gauge
∈₂=strain at a second strain gauge
∈₃=strain at a third strain gauge
   or:

$${M}_{I} = \frac{K}{\sqrt{3} r cos γ} ( {∈}_{3} - {∈}_{2} )$$

where:
Mₗ=a value proportional to the bending moment acting on the beam, and
K=a constant.

The method of determining a wheel load acting on a vehicle wheel may include providing a tyre pressure control system, the method including:
determining a target tyre pressure range of a vehicle tyre,
providing a tyre pressure sensor configured to measure an operating tyre pressure, and a tyre pressure adjustment device operable to adjust the pressure of the vehicle tyre,
monitoring the operating tyre pressure during a monitoring period to determine if the operating tyre pressure falls within the target tyre pressure range,
if the operating tyre pressure falls outside the target tyre pressure range, operating the tyre pressure adjustment device to adjust the operating tyre pressure towards the target tyre pressure range and/or to provide a signal to the user indicating that the operating tyre pressure falls outside the target tyre pressure range.

### BRIEF DESCRIPTION OF THE FIGURES

The invention will now be described, by way of example only, with reference to the accompanying drawings, in which:

FIG. 1 is an illustrative perspective view of parts of a wheel load determining apparatus;

FIG. 2 is an illustrative cross-sectional view of parts of the wheel load determining apparatus;

FIG. 3 is a top view of the wheel load determining apparatus;

FIG. 4 is an illustrative cross-sectional view of part of a wheel showing an exemplary configuration of the wheel load determining apparatus;

FIG. 5 is an illustrative cross-sectional view of part of a wheel assembly with a wheel load determining apparatus;

FIG. 6 is a further illustrative cross-sectional view of part of a wheel assembly with a wheel load determining apparatus; and

FIG. 7 is an illustrative cross-sectional view of part of a wheel assembly showing an alternative configuration of a wheel load determining apparatus.

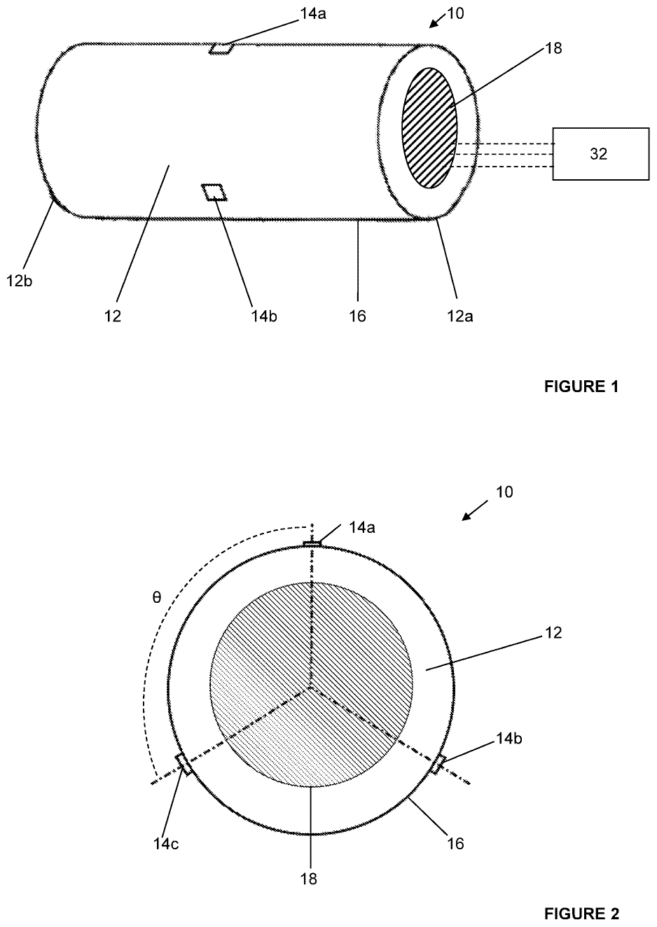

### DETAILED DESCRIPTION OF THE DISCLOSURE

With reference to the drawings, there is shown a wheel load determining apparatus 10 for determining a wheel load L of a vehicle. The wheel load determining apparatus 10 may include a beam 12 and one or more strain gauges 14.

The beam 12 may have a first end 12a and a second end 12b. The beam 12 may be configured to transfer at least a component of a wheel load L from a first vehicle wheel part to a second vehicle wheel part. The beam 12 may include a cylindrical portion having a substantially circular cross section. The cross-section of the beam 12 may be substantially uniform. The beam 12, or a portion of the beam 12, may have a cross-section that is not circular, and may be of any polygonal shape (rectangular, square, or triangular for example). The beam 12 or a portion of the beam 12 may be substantially solid in cross-section. The beam 12, may include an opening 18. The opening 18 may form a substantially hollow portion of the beam 12. The substantially hollow portion may extend between the first end 12a and the second end 12b of the beam 12, or may extend along a proportion of the length of the beam 12. The hollow portion of the beam 12 may have a tubular or box-like cross-section. The beam 12 may include a first portion and a second portion of different cross-sectional profiles. For instance, the first portion of the beam 12 may be substantially solid. The second portion of the beam 12 may be substantially hollow.

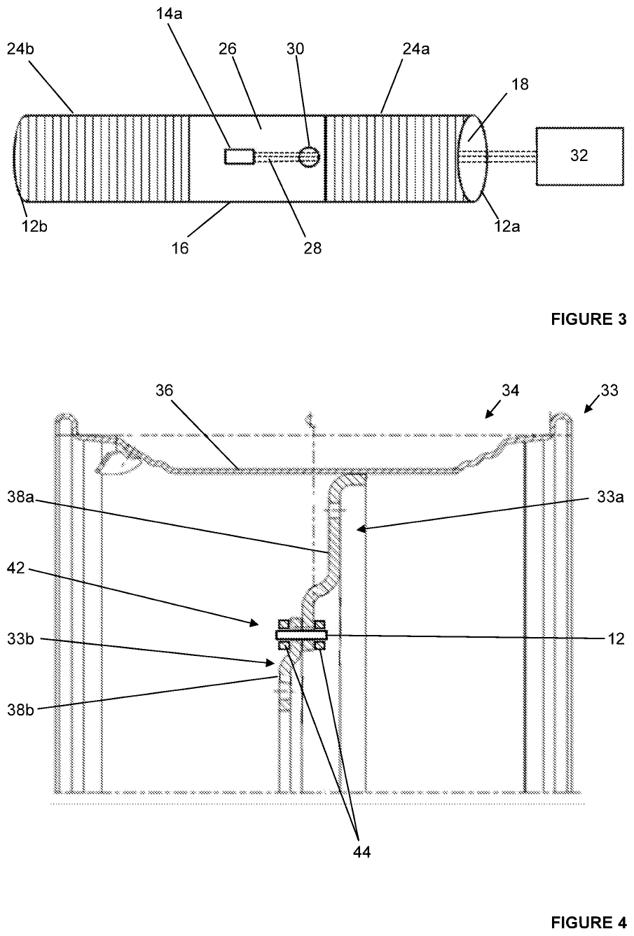

The beam 12 may include one or more threaded portions on its outer or inner surface 16. As shown in FIG. 3, for example, the beam 12 may include a first threaded portion 24a. The first threaded portion 24a may extend from the first end 12a of the beam 12 towards the second end 12b. The first threaded portion 24a may extend part way along the beam 12. The beam 12 may include a second threaded portion 24b. The second threaded portion 24b may extend from the second end 12b of the beam 12. It will be understood that the or each threaded portion 24a, 24b need not be positioned at an end 12a, 12b of the beam 12. The beam 12 may be a bolt or other connector.

The beam 12 may include one or more plain (e.g. unthreaded) portions 26. The or each plain portion 26 may be positioned between the first threaded portion 24a and the second threaded portion 24b, for example. The or each plain portion 26 may interrupt a threaded portion 24, 24b. The or each plain portion 26 may extend around the entire circumference or outer surface 16 of the beam 12, or may extend only partially around the circumference or outer surface 16 of the beam 12. The or each plain portion 26 may be flattened. The or each plain portion 26 may be configured to accommodate one or more strain gauges 14a, 14b, 14c and/or to enable one or more strain gauges 14a, 14b, 14c to be attached thereto.

The size of the or each plain portion 26 may correspond with the size of one or more strain gauges 14a, 14b, 14c. The or each plain portion 26 may enable one or more strain gauges 14a, 14b, 14c to be attached to the beam 12 without the or each threaded portion 24a, 24b interfering with the operation of the strain gauge 14a, 14b, 14c.

The beam 12 or a part of the beam 12 may be manufactured using a metallic material such as steel or aluminium. Additionally or alternatively, the beam 12 or a part of the beam 12 may be manufactured using a polymeric or composite material, provided that the beam 12 is capable of transferring at least a component of the wheel load L between the first vehicle wheel part and the second vehicle wheel part.

The wheel load determining apparatus 10 shown in the figures includes three strain gauges 14a, 14b, 14c, however, it will be understood that alternative numbers of strain gauges may be suitable or preferable. The or each strain gauge 14a, 14b, 14c may be an electrical strain gauge. Alternatively, the or each strain gauge 14a, 14b, 14c may be an optical strain gauge. The or each strain gauge 14a, 14b, 14c may be attached to the outer surface 16 of the beam 12. The strain gauges 14a, 14b, 14c may be positioned equidistantly from each other. For example, where three strain gauges 14a, 14b, 14c are used, the strain gauges 14a, 14b, 14c may be positioned at an angle 0 of 1200 from each other around the outer surface 16 of the beam 12. Each strain gauge 14a, 14b, 14c may be positioned at approximately the same axial position between the first end 12a, and the second end 12b of the beam 12. The or each strain gauge 14a, 14b, 14c may be attached to a corresponding plain portion 26 of the outer surface 16 of the beam 12. Each strain gauge 14a, 14b, 14c is shown on the outer surface 16 of the beam 12, but it will be appreciated that the or each strain gauges 14a, 14b, 14c or a subset of the strain gauges 14a, 14b, 14c may be positioned internally of the beam 12, for example on an inner surface of the beam 16.

The wheel load determining apparatus 10 may include a controller 32. The controller 32 may include a microcontroller. The controller 32 may be operable to receive signals from the or each strain gauge 14a, 14b, 14c. Each signal received by the controller 32 may be indicative of a strain measured by one or more of the strain gauges 14a, 14b, 14c. The controller 32 may be operable to use the signals indicative of strain to calculate a bending moment M acting on the beam 12 as a result of the component of the wheel load L. The controller 32 may also include a data storage device such as random access memory (RAM) and/or read only memory (ROM). The controller 32 may record signals from the strain gauges 14 and/or results of calculations performed by the controller 32. The controller 32 may be communicable with additional components. For example, the controller 32 may be operable to receive signals from sources in addition to or other than the or each strain gauge 14a, 14b, 14c, and/or be operable to provide output signals. Output signals from the controller 32 may be provided to a display device, an alerting device, and/or a centralised tyre pressure control device (CTPC), for example.

The wheel load determining apparatus 10 may include a connection 28 from the or each strain gauge 14a, 14b, 14c. The controller 32 may be operable to send and/or receive signals to/from the or each strain gauge 14a, 14b, 14c via the connection 28. The connection 28 may be provided by one or more electrical wires. Alternatively, the connection 28 may be a wireless connection, using a radio frequency transceiver, for instance. The connection 28 may be operable to transmit signals from the or each strain gauge 14a, 14b, 14c to the controller 32. Each signal may be indicative of the deformation measured by a corresponding strain gauge 14a, 14b, 14c.

In the case of a connection 28 provided by one or more electrical wires, the or each wire may pass from the outer surface 16 of the beam 12 to the opening 18 of the beam 12. The wire 28 passes through a wire passage 30 between the outer surface 16 and the opening 18 of the beam 12. Where multiple strain gauges 14a, 14b, 14c are provided, multiple wires and multiple wire passages 30 may be provided. The or each wire may then pass through the opening 18 and exits the beam 12, for example at the first end 12a or the second end 12b of the beam 12. This arrangement reduces the possibility of damage occurring to the connection 28, since the connection 28 is protected by the beam 12, and allows the wire 28 to pass between the or each strain gauge 14a, 14b, 14c and the controller 32 without interfering with the or each threaded portion 24, for example.

The or each strain gauge 14a, 14b, 14c may be formed of a fine wire arranged in a convoluted pattern. The pattern ensures that the amount of wire aligned in the direction of measurement is maximised. The or each strain gauge 14a, 14b, 14c may be bonded to an outer surface 16 of the beam 12. When a load is applied to the beam 12, the beam 12 will deform in proportion to the magnitude of the load L, causing the wires in the or each strain gauge 14a, 14b, 14c, that are bonded to the surface of the beam 12 to extend or contract. This causes a small change in resistance in the gauge 14. To measure the small changes in resistance, the strain gauges 14a, 14b, 14c may be part of a Wheatstone bridge arrangement. Such an arrangement relies on the balance of resistance in two parallel voltage divider circuits. Small changes in the resistance of one or more of the strain gauges 14a, 14b, 14c results in an imbalance in the circuit. The imbalance may be represented by a signal. The magnitude of the signal may be representative of the deformation measured at the or each strain gauge 14a, 14b, 14c.

An appropriate low pass frequency and/or an appropriate high pass frequency may be applied to signals passed to the controller 32. The low pass frequency may be between 3 and 10 Hz for example. Additionally, or alternatively the high pass frequency may be between 0.25 and 1 Hz for example.

FIGS. 4, 5, 6 and 7 show part of a vehicle wheel assembly 33. The wheel load determining apparatus 10 may be associated with the vehicle wheel assembly 33 to measure a wheel load experienced by the vehicle wheel assembly 33 or a part of the vehicle wheel assembly. The vehicle wheel assembly 33 may include a first assembly part 33a and a second assembly part 33b. The first assembly part and the second assembly part may be different parts of the wheel assembly 33. The first assembly part 33a may be separate from the second assembly part 33b. The first and second wheel assembly parts 33a, 33b may be connected together. The first and second wheel assembly p-arts 33a, 33b may be connected together by a part of the wheel load determining apparatus 10.

The wheel assembly 33 may be a vehicle wheel 34. The wheel 34 includes a rim 36 and a disc 38. The first assembly part 33a may be a first part of the wheel 34 and the second assembly part 33b may be a second part of the wheel 34.

The first assembly part 33a may be a first disc part 38a and the second assembly part 33b may be a second disc part 38b. An example of this type of arrangement is shown in FIG. 4.

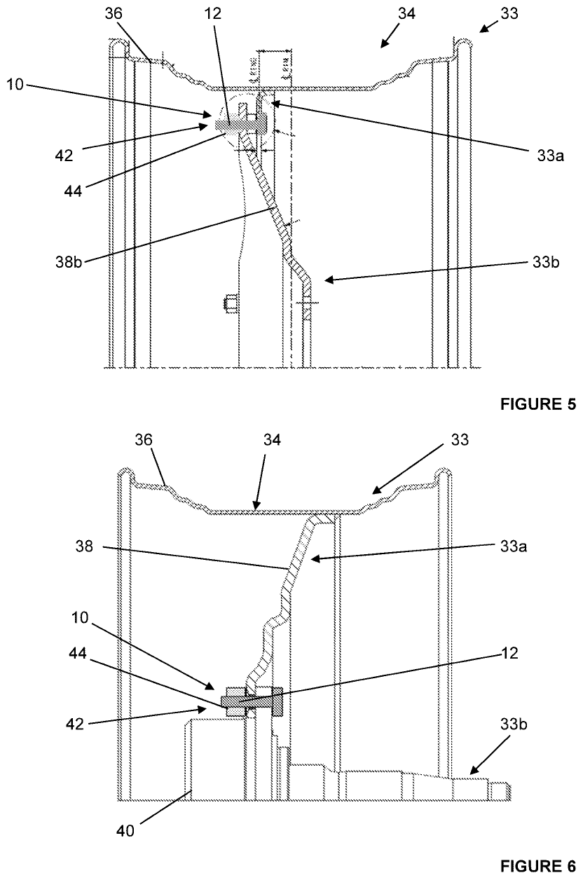

The first assembly part 33a may be a part of the rim 36 and the second assembly part 33b may be a part of the disc 38. An example of this type of arrangement is shown in FIG. 5.

The first assembly part 33a may be a part of the wheel 34, for example a part of the disc 38, and the second assembly part 33b may be a part of a hub 40 of the vehicle. An example of this type of arrangement is shown in FIG. 6.

A plurality of connectors, for example bolts, may be operable to connect the first assembly part 33a to the second assembly part 33b. The wheel load determining apparatus 10 may form part of a bolted joint 42 connecting the first assembly part 33a to the second assembly part 33b. The connection formed by the wheel load determining apparatus 10 may be suitable for transferring at least a component of wheel load L between the first assembly part 33a to the second assembly part 33b. The beam 12 may be configured as a connector to connect the first assembly part 33a to the second assembly part 33b. One or more of the connectors, including the or each beam 12, where used as a connector, may be a bolt. One or more of the connectors may be mounted with a nut 44.

The or each nut 44 (or a subset of the nuts 44 where a plurality of bolts and nuts are provided) may be configured to ensure that the component of the wheel load may be accurately measured by the or each strain gauge 14a, 14b, 14c. One or more nuts 44 may be a conical or spherical nut 44 having a conical or spherical seat. The or each conical or spherical nut 44 may be configured to align the beam 12. This may provide an optimised load path from the first assembly part 33a to the second assembly part 33b. The or each nut 44 may locate the beam 12, centrally within fixing holes in the first assembly part 33a and/or the second assembly part 33b in the wheel assembly 33. The or each nut 44 may contact the first assembly part 33a and/or the second assembly part 33b while the beam 12 remains clear of the first assembly part 33a and/or the second assembly part 33b.

A torque may be applied to the or each nut 44 to fasten the first assembly part 33a and the second assembly part 33b together. The torque applied to each nut 44 may be in the range of 200 Nm to 800 Nm, for example, and may be in the range of 550 to 650 Nm.

The beam 12 may be fixed to the first assembly part 33a and/or the second assembly part 33b by means other than a nut 44 and threaded portions 24, i.e., by any appropriate means. Such means may include an interference fit between the wheel load determining apparatus 10 and the first assembly part 33a and/or the second assembly part 33b, for example. Alternatively, the wheel load determining apparatus 10 may be bonded, braised, welded or otherwise fixed to the first assembly part 33a and/or the second assembly part 33b.

The controller 32 may be mounted on an outer surface of the vehicle wheel 34, for instance on the disc 38, such that it is visible and/or accessible during normal use, for example when the vehicle wheel 34 is fitted on the vehicle. This allows the controller 32 to be fitted and/or serviced without removing the vehicle wheel. Alternatively, the controller 32 may be mounted on an inner surface of the vehicle wheel 34, such that is not visible during normal use. The controller 32 may be located remotely from the vehicle wheel 34. The controller 32 may be located in or on the beam 12.

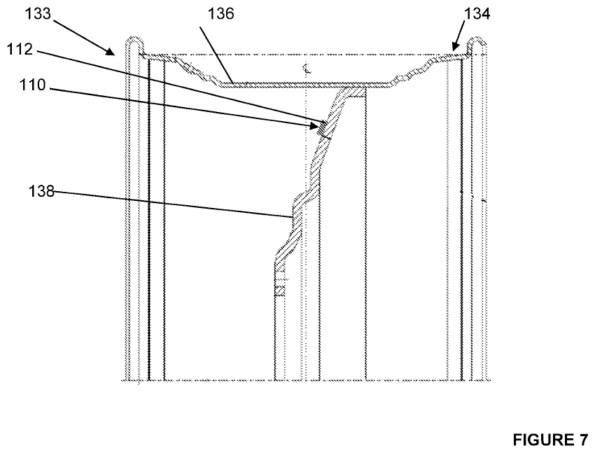

FIG. 7 shows a part of a vehicle wheel assembly 133. The vehicle wheel assembly 133 may include a vehicle wheel 134, having a rim 136 and a disc 138. In embodiments, the vehicle wheel assembly may include a vehicle wheel (for example as shown in FIGS. 4-7) and another vehicle component, for example a hub, to which the wheel 134 is connectable.

In the example shown, the disc 138 is shown as a one-piece disc, but may be a multi-part disc. A wheel load determining apparatus 110 which includes a plurality of strain gauges is associated with the vehicle wheel 134. The wheel load determining apparatus 110 may include a beam but does not require a beam.

The vehicle wheel assembly 133 may include a first assembly part and a second assembly part. In the example shown, the wheel load determining apparatus 110 is positioned on a single part of the vehicle wheel assembly 133, i.e. in the example shown, the wheel load determining apparatus 110 does not span two parts of the wheel 134 and is not used to connect two parts of the wheel 134 together. The measurements of each strain gauge relate to the same part of the wheel assembly (in this case the disc 138 of the wheel 134). It will be appreciated that strain gauges may be located on more than one part 133a, 133b of the vehicle wheel assembly 133. A beam may be included as part of the wheel load determining apparatus 110, but is not essential. Each strain gauge may be connected to a part of the vehicle wheel assembly 33, 133, for example fixed directly to a part of the vehicle wheel assembly 33, 133. The or each strain gauge may be operable to measure the deformation of a part of the vehicle wheel assembly 33, 133.

The wheel load determining apparatus 10, 110 may be provided on a low stress area of the vehicle wheel assembly 33, 133. Where a beam 12, 112 is provided as part of the wheel load determining apparatus, the beam 12, 112 may be installed on a low stress area of the vehicle wheel assembly 133. The wheel load determining apparatus 10, 110 may be installed on a low stress area of the disc 38,138. In a low stress region, for example the disc 138, deformation may be proportional to the wheel load L, or component of the wheel load L. The signals received by the controller 32 are indicative of the deformation measured by the or each strain gauge in the low stress region of the vehicle wheel assembly 33, 133, for example a part of the wheel disc 38, 138.

A plurality of wheel load determining devices 10, 110 may be associated with the vehicle wheel 34, 134. It will be appreciated that more than one beam 12, 112 may be included in the vehicle wheel 34. Each beam 12, 112 may be used as a connector between the same first and second vehicle wheel parts, or each beam 12, 112 may connect different first and second vehicle wheel parts.

When a wheel load L acts on the vehicle wheel 34, 134 at least a component of the wheel load L is transferred in a load path. A part of the load path may be monitored. The monitored part of the load path may be between the first part of the wheel 34, 134 and the second part of the wheel or may be in a single part of the wheel 34, 134. In order to achieve an accurate measurement of the wheel load L it is important that the load path or part of the load path between the first wheel part 38 and second wheel part 40 passes through the wheel load determining apparatus 10, in particular through the beam 12, 112, where the wheel load determining apparatus 10, 110 includes a beam 12, 112.

Where a beam 12, 112 is provided, the wheel load L or component of the wheel load L acting upon the beam 12, 112 may cause the beam 12, 112 to deform. The wheel load L or component of the wheel load L may cause a bending moment M in on the beam 12, 112. The or each strain gauge 14a, 14b, 14c associated with the beam 12, 112 is operable to measure deformation, e.g. strain, in the beam 12, 112. The or each strain gauge 14a, 14b, 14c is operable to send a signal indicative of the deformation of the beam 12, to the controller 32. Where a beam 12, 112 is not provided, the or each strain gauge may measure the deformation of the first and/or second wheel part directly. The controller 32 may be operable to receive and process the signals from the or each strain gauge 14a, 14b, 14c.

A method of calibrating the wheel load determining apparatus 10 is outlined below. A first measurement may be taken at a first known wheel load L₁. The load L₁ may cause a bending moment M₁ will act on the beam 12, 112. The first load L₁ may correspond to a situation where the vehicle is unladen, for example, that is to say that the vehicle is not carrying any load in excess of the weight of the vehicle. The deformation in the beam 12, 112 will be measured by the or each strain gauge 14a, 14b, 14c at the first load L₁. The or each deformation may be communicated to the controller 32 as one or more signals. The signals may be indicative of the deformation measured by the or each strain gauge 14a, 14b, 14c, and/or a combination of the deformation measurements. The controller 32 may then calculate the or each value of strain from the one or more signals. Using this data, the controller 32 may calculate a value indicative of the first bending moment M₁ acting on the beam 12, 112, at the first known wheel load L₁. The value indicative of the first bending moment M₁ may be a value proportional to the first bending moment M₁. The value indicative of the first bending moment M₁ may be equal to the value of the first bending moment M₁. The value indicative of the first bending moment M₁, may be recorded by the controller 32. The first known wheel load L₁ may be stored associated with the first bending moment M₁, or with the value indicative of the first bending moment M₁.

A second measurement may be taken at a second known wheel load L₂. The load L₂ may cause a bending moment M₂ to act on the beam 12, 112. The second load L₂ may correspond to a situation where the vehicle is carrying a known load, for example in excess of the vehicle weight. The deformation in the beam 12, 112 will be measured by the or each strain gauge 14a, 14b, 14c at the second load L₂. The or each deformation measurement may be communicated to the controller 32 as one or more signals, indicative of the deformation measured by the or each strain gauge 14a, 14b, 14c. The controller 32 may then calculate the or each value of strain from the one or more signals. The controller 32 may calculate a value indicative of the second bending moment M₂ acting on the beam 12, 112 at the first known wheel load L₂. The value indicative of the second bending moment M₂ may be a value proportional to the second bending moment M₂. The value indicative of the second bending moment M₂ may be equal to the value of the second bending moment M₂. The second measurement may then be recorded by the controller 32. The second known wheel load L₂ may be stored associated with the second bending moment M₂, or with the value indicative of the second bending moment M₂. This process may be repeated as many times as necessary to determine a load function M(L) of the bending moment M acting on the beam 12, 112, or a value indicative the bending moment M acting on the beam 12, 112, with respect to wheel load L.

The controller 32 may then determine a load function M(L) of the bending moment M acting on the beam 12, 112, or a value indicative of (for example, proportional to) the bending moment M acting on the beam 12, 112, with respect to wheel load L. The load function M(L) may be determined using at least two measurements, relating to two calculated bending moments M₁ and M₂, or to values indicative of the first and second bending moments M₁ and M₂ taken at loads L₁ and L₂. It has been found that the function M(L) may be assumed to be a linear relationship and may therefore be determined by two or more measurements. The load function M(L) may be stored in the memory of the controller 32.

The bending moment M may be calculated using the equation:

$$M = \frac{IE}{\sqrt{3} r cos γ} ( {∈}_{3} - {∈}_{2} )$$

$$where$$

$$γ = {tan}^{- 1} \{ \frac{1}{\sqrt{3}} \vert 1 - \frac{2 ( {∈}_{1} - {∈}_{3} )}{( {∈}_{2} - {∈}_{3} )} ] \}$$

and
M=the bending moment acting on the beam
E=Modulus of elasticity of the beam
I=Second moment of inertia of the beam
r=radius of cross section of the beam
∈₁=strain at a first strain gauge 14a.
∈₂=strain at a second strain gauge 14b
∈₃=strain at a third strain gauge 14c.

An alternative value indicative of the bending moment, Mᵢ, may be represented as follows:

$${M}_{I} = \frac{K}{\sqrt{3} r cos γ} ( {∈}_{3} - {∈}_{2} )$$

where
K=a constant.

If a constant value K is used instead of the value IE, the value calculated will be proportional to the bending moment M acting on the beam, and this value will still be proportional to the load L acting on the wheel.

The vehicle may be driven in a substantially straight line during calibration, and/or during determination of wheel load L.

Calibration may take place after installation of the wheel 34, 134 on the vehicle.

During and/or after calibration, deformation in the beam 12, 112 may be monitored during a measuring period. For instance, measurements may be taken at intervals of time over the measuring period, for example, but not limited to, every second or every minute, for example in accordance with a predetermined duty cycle. The measurement period may be started by a trigger event. The trigger event may be a user input, for example a signal from the wheel load determining apparatus 10, 110 itself, or an input from a system or component that is external to the wheel load determining apparatus 10, 110. Monitoring of the deformation of the beam 12, 112 may end after a predetermined time period has passed, i.e. the measurements may stop once the measuring period ends.

An operating wheel load L_{O} relates to the wheel load L when the vehicle is in normal use. The operating wheel load L_{O} may be unknown and may be determined by using the following method. The deformation in the beam 12, 112 will be measured by the or each strain gauge 14a, 14b, 14c at the operation wheel load L_{O}. The or each deformation measurement will be communicated to the controller 32 as one or more signals, indicative of the deformation measured by the or each strain gauge 14a, 14b, 14c. The controller 32 may then calculate the or each value of strain from the one or more signals. The controller 32 may calculate the bending moment M_{O} acting on the beam 12 at the wheel load L_{O}, or a value proportional to the bending moment M_{O} acting on the beam 12 at the wheel load L_{O}. The operating wheel load L_{O} can then be derived by considering the operating bending moment M_{O}, or the value proportional to M_{O}, in relation to the load function M(L).

Alternatively, or additionally, the controller 32 may determine a strain load function S(L), considering the strain measurements rather than the bending moment in beam 12. The wheel load may then be inferred by considering an operating strain S_{O} with respect to a strain load function S(L).

The method of determining the wheel load L may be used while the vehicle wheel 34 is stationary or while the vehicle wheel 34 is rotating, i.e. while the vehicle is being driven. This is because the or each strain gauge 14a, 14b, 14c may measure deformation and during use or while the vehicle is stationary. The signals, indicative of the measured deformation, may also be communicated to the controller 32 when the vehicle is stationary and/or when in use. The controller 32 may be operable to determine the load function M(L) and/or the strain load function S(L) while the vehicle is in use or while the vehicle is stationary. The controller 32 may also be operable to determine the operating wheel load L_{O} based on the bending moment load function M(L) or the strain load function S(L), while the vehicle is in use or while the vehicle is stationary. The load function M(L) and/or the strain function S(L) may be stored by the controller 32 while the vehicle is in use or while the vehicle is stationary.

The operating bending moment M_{O}, or a value indicative of the operating bending moment M_{O}, may be calculated during a calculation period during multiple cycles or wheel revolutions. A maximum and minimum value for the operating bending moment M_{O} may be determined. Alternatively, an average value for operating bending moment M_{O} may be determined.

The calculation period may occur simultaneously with the measuring period, i.e. the calculation of the bending moment M or of a value proportional to the bending moment M, may occur contemporaneously with the collection of data, e.g. in real time. The value indicative of the bending moment M, whether taken as a maximum, minimum or an average, may then be updated during the calculation period.

The signals resulting from the changes of resistance in the or each strain gauge 14 may be processed using a low pass filter and/or a high pass filter. The low pass filter and/or high pass filter may be configured to attenuate radio frequency interference in signals from the or each strain gauge 14a, 14b, 14c. As the signal is representative of the deformation in the beam 12, 112, any interference in the signal may result in errors in the reported deformation of the beam 12. The high pass filter and/or the low pass filter may be operable to reduce the effect of signal drift.

It will be appreciated that where a beam is not provided, the same method may be used, using strain measurements of the or each strain gauge and the strain load function S(L) to determine the vehicle wheel load.

The wheel load determination device 10 may form part of or provide data to a centralised tyre pressure control system (CTPC). The CTPC may include one or more tyre pressure sensors and a tyre pressure adjustment device operable to inflate or deflate one or more vehicle tyres. The tyre pressure adjustment device may include a compressor. The tyre pressure adjustment device may be operable to adjust one or more tyre pressures automatically in response to one or more signals and/or a predetermined condition being met.

The CTPC monitors an operating tyre pressure P_{O} during a monitoring period in order to determine if the operating pressure P_{O} of the vehicle tyre is equal to a target tyre pressure P_{T}. The target tyre pressure P_{T} may be a range of acceptable values. The acceptable range of target tyre pressure P_{T} required to achieve a desired tyre contact area may vary depending on the operating wheel load L_{O}. For instance, in order to achieve a desired level of tyre deformation, a higher target tyre pressure P_{T} may be required when the operating wheel load L_{O} is relatively higher. Conversely, a lower target tyre pressure P_{T} may be required when the operating wheel load L_{O} is relatively lower. Therefore, a target tyre pressure P_{T} can be selected based on the operating wheel load L_{O} and the type of working terrain.

The target tyre pressure range P_{T} may be selected based on a desired tyre deformation and the operating wheel load L_{O}. The desired tyre deformation may be selected based on the type of terrain that the vehicle is travelling across or intending to travel across. The operating wheel load L_{O} may be measured using the wheel load determination apparatus 10, 110.

If the CTPC determines that the operating pressure P_{O} is outside of the target tyre pressure range P_{T}, the CTPC may operate the tyre pressure adjustment device in order to adjust the operating pressure P_{O} of such that the operating tyre pressure P_{O} falls within the target tyre pressure range P_{T}. The CTPC may be operate while the vehicle is moving or while otherwise in use. The CTPC may additionally or alternatively be used while the vehicle is stationary.

The CTPC may be operable determine a target tyre pressure range P_{T} based on a desired tyre deformation and operating wheel load L_{O} and, if the operating pressure P_{O} is not within the target tyre pressure range P_{T}, adjust the operating pressure P_{O} of the or each vehicle tyres towards the target tyre pressure range P_{T}.

It has been determined that when the vehicle wheel is moving in a substantially straight line (i.e. is not turning), the bending moment M acting on the beam is proportional to the radial load acting on the wheel, with very low influence from other parameters such as tyre pressure, tyre characteristics, rotational speed or clamping torque of a bolt.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A wheel load determining apparatus for determining a wheel load acting on a vehicle wheel, wherein the wheel is part of a wheel assembly, the wheel assembly including a first assembly part and a second assembly part, wherein a component of the wheel load is transferred between the first assembly part and the second assembly part, the wheel load determining apparatus including at least one strain gauge positioned and configured to measure deformation between the first assembly part and the second assembly part, and to provide a signal indicative of measured deformation to a controller configured to receive a signal indicative of deformation and to determine a value indicative of a bending moment resulting from the component of the wheel load, wherein the controller determines the wheel load acting on the vehicle wheel based on the determined value indicative of the bending moment and a load function which represents a relationship between the value indicative of bending moment and the wheel load.

2. A wheel load determining apparatus according to claim 1, including:
a beam configured to transfer a load component between a first assembly part and a second assembly part of a wheel assembly
at least one strain gauge positioned on a surface of the beam and configured to measure a deformation of the beam due to the wheel load component and to provide a signal indicative of the deformation of the beam, to a controller configured to receive a signal indicative of deformation of the beam, and to determine a value indicative of a bending moment acting on the beam, as a result of the load component,
wherein the controller determines the wheel load acting on the vehicle wheel based on the determined value indicative of bending moment acting on the beam and a load function which represents a relationship between the value indicative of bending moment and the wheel load.

3. A wheel load determining apparatus according to claim 1 or claim 2 wherein the first assembly part is a part of the vehicle wheel.

4. A wheel load determining apparatus according to any preceding claim wherein the first assembly part is a part of a disc of the vehicle wheel.

5. A wheel load determining apparatus according to any of claims 1 to 3 wherein the first assembly part is a part of a rim of the vehicle wheel.

6. A wheel load determining apparatus according to any of claims 3 to 5 wherein the second assembly part is a second part of the disc of the vehicle wheel.

7. A wheel load determining device according to any of claims 3 to 5 wherein the second assembly part is a part of a hub of the wheel assembly.

8. A wheel load determining apparatus according to any preceding claim wherein the beam provides a connection between the first assembly part and the second assembly part.

9. A wheel load determining apparatus according to any preceding claim wherein the beam comprises a threaded portion.

10. A wheel load determining apparatus according to any preceding claim wherein the beam forms part of a bolted joint between the first assembly part and the second assembly part.

11. A wheel load determining apparatus according to claim 10 wherein a conical or spherical nut is used to fasten the beam in the bolted joint.

12. A wheel load determining apparatus according to any preceding claim, including a plurality of strain gauges, each positioned on a surface of the beam, and each being operable to measure a component of the deformation of the beam.

13. A vehicle wheel including a wheel load determining apparatus in accordance with claims 1 to 12.

14. A tyre pressure control system configured to monitor the pressure of a vehicle tyre, wherein the tyre pressure control system is configured to receive data indicative of a wheel load from a wheel load determining apparatus in accordance with any of claims 1 to 12.

15. A tyre pressure control system according to claim 14 configured to use the data indicative of a wheel load received from the wheel load determining apparatus to determine and/or monitor pressure of the vehicle tyre, the tyre pressure control system being operable to determine whether the tyre pressure is within a predetermined range.

16. A tyre pressure control system according to claim 15 operable to provide an indication to a user that the tyre pressure is and/or is not within the predetermined range.

17. A tyre pressure control system according to claim 15 or 16 operable to provide a signal that enables automatic adjustment of the tyre pressure.

18. A vehicle including a vehicle wheel in accordance with claim 13, including a wheel load determining apparatus.

19. A vehicle according to claim 18 including a tyre pressure control system according to any of claims 14 to 17.

20. A method of determining a wheel load acting on a vehicle wheel, the wheel being part of a wheel assembly including a first assembly part and a second assembly part, a component of the wheel load being transferred between the first assembly part and the second assembly part, the method including the steps of:
providing a wheel load determining apparatus, including:
at least one strain gauge configured to measure deformation of the beam due to the wheel load component and to provide a signal indicative of the deformation, and
a controller configured to receive signals indicative of deformation and to determine a value indicative of a bending moment acting on the beam;
measuring deformation between the first assembly part and the second assembly part due to a wheel load using the at least one strain gauge,
receiving a signal indicative of deformation at the controller,
determining a value indicative of a bending moment due to the component of the wheel load, using the signal indicative of deformation, and
determining the wheel load acting on the vehicle wheel,
wherein the determination of the wheel load acting on the vehicle wheel is based on the value indicative of bending moment and a load function which represents a relationship between the value indicative of bending moment and the wheel load.

21. A method according to claim 20, including the steps of:
providing a wheel load determining apparatus that includes:
a beam operable to transfer a component of the load between the first assembly part and the second assembly part,
providing at least one strain gauge configured to measure deformation of the beam due to the component of the wheel load and to provide a signal indicative of the deformation of the beam, and
providing a controller operable to receive signals indicative of the deformation of the beam and to determine a value indicative of a bending moment acting on the beam, measuring the deformation of the beam due to a wheel load using the at least one strain gauge operable to measure strain in the beam,
receiving a signal indicative of deformation of the beam at the controller,
determining a value indicative of bending moment acting on the beam due to the wheel load using the signal indicative of deformation of the beam, and
determining the wheel load acting on the vehicle wheel,
wherein the determination of the wheel load acting on the vehicle wheel is based on the value indicative of bending moment acting on the beam and a load function which represents a relationship between the value indicative of bending moment and the wheel load.

22. A method according to claim 20 or 21 wherein the first assembly part is a part of the vehicle wheel.

23. A method according to any of claims 20 to 22 wherein the first assembly part is a part of a disc of the vehicle wheel.

24. A wheel load determining apparatus according to claim 22 wherein the first assembly part is a part of a rim of the vehicle wheel.

25. A method according to any of claims 22 to 24 wherein the second assembly part is a part of the disc of the vehicle wheel.

26. A method according to any of claims 20 to 24 wherein the second assembly part is a part of a hub of the wheel assembly.

27. A method according to any of claims 21 to 26 wherein determining the operating wheel load includes a calibration phase, the calibration phase including:
measuring a first deformation of the beam at a first known wheel load, using at least one strain gauge,
measuring a second deformation of the beam at a second known wheel load, using at least one strain gauge,
calculating a first value indicative of bending moment acting on the beam at the first known wheel load,
calculating a second value indicative of bending moment acting on the beam at the second known wheel load,
determining the load function of value indicative of bending moment acting on the beam with respect to wheel load using the first known wheel load, the first value indicative of bending moment, the second known wheel load and the second value indicative of bending moment.

28. A method according to one of claims 21 to 27 wherein a value indicative of the bending moment acting on the beam is calculated using one of
$$M = \frac{IE}{\sqrt{3} r cos γ} ( {∈}_{3} - {∈}_{2} )$$
$$where$$
$$γ = {tan}^{- 1} \{ \frac{1}{\sqrt{3}} \vert 1 - \frac{2 ( {∈}_{1} - {∈}_{3} )}{( {∈}_{2} - {∈}_{3} )} ] \}$$
and:
M=the bending moment acting on the beam
E=Modulus of elasticity of the beam
I=Moment of inertia of the beam
r=radius of cross section of the beam
∈₁=strain at a first strain gauge
∈₂=strain at a second strain gauge
∈₃=strain at a third strain gauge
or:
$${M}_{I} = \frac{K}{\sqrt{3} r cos γ} ( {∈}_{3} - {∈}_{2} )$$
where
Mᵢ=a value proportional to the bending moment acting on the beam, and
K=a constant.

29. A method according to one of claims 20 to 28 including providing a tyre pressure control system, the method including:
determining a target tyre pressure range of a vehicle tyre,
providing a tyre pressure sensor configured to measure an operating tyre pressure, and a tyre pressure adjustment device operable to adjust the pressure of the vehicle tyre,
monitoring the operating tyre pressure during a monitoring period to determine if the operating tyre pressure falls within the target tyre pressure range,
if the operating tyre pressure falls outside the target tyre pressure range, operating the tyre pressure adjustment device to adjust the operating tyre pressure towards the target tyre pressure range and/or to provide a signal to the user indicating that the operating tyre pressure falls outside the target tyre pressure range.
